(19) United States
(12) Patent Application Publication
(10) Pub. No.: US 2004/0104907 A1
(43) Pub. Date: Jun. 3, 2004

(54) Image display device having functions for protecting an address driver

(75) Inventor: Kwang-Hoon Jeon, Goyang-city (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/721,379

(22) Filed: Nov. 26, 2003

(30) Foreign Application Priority Data
Nov. 30, 2002 (KR) 2002-75648

(51) Int. Cl. G09G 5/00

(52) U.S. Cl. 345/204

(57) ABSTRACT

Disclosed is an image display device having functions for protecting an address driver. The image display device includes a panel provided with address electrodes and data electrodes, a scaler for converting an input image signal to fit into a resolution of the panel, an address driver and a data driver for driving the address electrodes and the data electrodes, respectively, in response to an image signal from the scaler, and a luminance control unit for comparing line by line changes of the image signal outputted from the scaler, changing luminance of the image signal outputted from the scaler, and changing the number of operations of the address driver. Such an image display device decreases a parasitic capacitance in an address driver for driving a PDP, to thereby prevent the address driver from being overloaded.

### CROSS-REFERENCE TO RELATED APPLICATIONS

This application claims the benefit of Korean Patent Application No. 2002-75648, dated Nov. 30, 2003, in the Korean Intellectual Property Office, the disclosure of which is incorporated herein by reference.

### BACKGROUND OF THE INVENTION

1. Field of the Invention

The present invention relates to a plasma display device, and more particularly, to a plasma display device having functions for protecting an address driver.

2. Description of the Related Art

A plasma display device is a kind of display device having plural discharge cells arranged in a matrix configuration. The discharge cells are selectively excited to recover image data, and each of the discharge cells constituting the plasma display device needs a discharge sustain voltage for sustaining discharging therein. Therefore, a high discharge sustain voltage is applied to the discharge cells constituting the plasma display device, which causes power consumption higher than different display devices such as CRT, LCD, and so on.

FIG. 1 is a vertically cross-sectioned view for showing a discharge cell constituting a plasma display device.

FIG. 1 shows a discharge cell of AC type having two glass substrates 10 and 11 arranged to face each other, and, of the two glass substrates 10 and 11, in the upper substrate 10 is disposed discharge sustain electrodes 12 and 13, and in the lower substrate 11 is disposed an address electrode 14. Further, a dielectric layer 15 is formed between the two discharge sustain electrodes 12 and 13 disposed in the upper substrate 10, and a protection layer of MgO film is deposited on the dielectric layer 15. Further, a discharge gas such as He, Ne, Xe, or a mixture of the above gases is generally filled between the upper and lower substrates 10 and 11 in a pressure range of 300˜500 torr. The discharge cell having the above structure emits light by electric discharge occurring between the discharge sustain electrodes 12 and 13 when a high voltage pulse is applied to the discharge sustain electrodes 12 and 13 formed in the upper substrate 10, and accumulates electric charge on the dielectric layer 15. Accordingly, a voltage applied to the discharge sustain electrodes 12 and 13 can be reduced by a charge amount accumulated on the dielectric layer 15. At this time, the charge amount accumulated on the discharge sustain electrodes 12 and 13 is proportional to a dielectric constant of the dielectric layer 15, and the electric charge accumulated on the dielectric layer 15 is generally called “wall charge”.

FIG. 2 is a graph for showing discharge characteristics of the discharge cell shown in FIG. 1.

In FIG. 2, it can be seen that a discharge ignition voltage for the discharge cell to emit light is much higher than a discharge sustain voltage. The discharge sustain voltage is a voltage enabling the discharge cell to constantly emit light, which has a lower voltage compared to a discharge ignition voltage in general due to a voltage formed by charges accumulated on the dielectric layer 15 by the discharge initiation voltage. This is an electric characteristic of the discharge cell that the discharge sustain voltage becomes lower as a charge amount accumulated on the dielectric layer 15 constituting the discharge cell becomes larger.

FIG. 3 is an exploded perspective view for showing a plasma panel constituted with the discharge cells shown in FIG. 1, and also shows a structure of a commercialized plasma panel. The plasma panel is structured with discharge sustain electrodes 12a˜12cand 13a˜13c embedded side by side in discharge spaces formed by barrier ribs 20a˜20d and data electrodes oppositely traversing the discharge sustain electrodes 12a˜12c and 13a˜13c. Light-emitting layers 21a˜21c formed between the barrier ribs 20a˜20d are stimulated by ultraviolet light emitted due to a high voltage pulse applied to the discharge sustain electrodes 12a˜12c and 13a˜13c, to thereby emit visible light. Each of the barrier ribs 20a˜20d prevents the visible light emitted out of the light-emitting layer 21a˜21c from affecting each other.

In the meantime, images are displayed by turning on and off individual discharge cells constituting the plasma panel having the above structure, so that the plasma panel is driven in a digital manner differently from a general Braun tube such as a cathode ray tube (CRT). The CRT linearly changes the intensity of electron beams scanned on individual pixels to control the light-emitting intensity of fluorescent material, whereas the plasma panel controls the light-emitting intensity by regulating a discharge sustain period during which a discharge sustain voltage is applied. Hereinafter, the luminance control of the plasma panel and electric power consumption resulting from the luminance control will be described with reference to the accompanying drawings.

FIG. 4 is a view for explaining a method representing the luminance of the plasma panel.

The horizontal axis shown in FIG. 4 represents time, and the vertical axis represents the number of horizontal scan lines. The shown luminance representation method is an 8-bit luminance implementation method, which divides one field into eight sub-fields. Each sub-field has a reset period, an address period, and a discharge sustain period, which are separated from each other. The reset period is a period for initializing the plasma panel, the address period is a period for selecting a certain spot of the plasma panel, and the discharge sustain period is a period for emitting light at the selected spot of the plasma panel. During the address period, voltages of +50V and −150V are applied to the discharge sustain electrodes 12 and 13. Therefore, the discharge cell emits light during the discharge sustain period by a voltage difference between the discharge sustain electrodes 12 and 13.

Sub-fields having different light emission periods, for example, 1T, 2T, 4T, 8T, 16T, 32T, 64T, and 128T, are set to be selectively turned on and off during the discharge sustain period, and, accordingly, the discharge cell has a unique luminance value based on turning on and off the sub-fields having different light emission periods. For example, in order to obtain the luminance of a level of 127, the sub-fields from 1T to 7T are sequentially turned on and off. That is, the addition of luminance values of the individual sub-fields produces the luminance value of the level of 127 since 1+2+4+8+16+32+64=127. In such a method, the luminance can be represented in 256 gray levels (2⁸) in a case in which all eight sub-fields are used.

FIG. 5 is a block diagram for conceptually showing a conventional plasma display device.

The plasma display device shown in FIG. 5 has an analog-digital (A/D) converter 40, a scaler 50, a plasma panel driver 60, and a plasma panel (PDP) 70.

The A/D converter 40 inputs and converts into a digital signal an external image signal of RGB format or an image signal of RGB format from a personal computer (not shown).

The scaler 50 converts a digital image signal outputted from the A/D converter 40 to fit into a screen size of the PDP 70.

The PDP driver 60 inputs the digital image signal converted in the scaler 50, and converts the inputted digital image signal into a signal for driving the PDP 70. For example, the PDP driver 60 generates a data pulse and an address pulse for selecting discharge cells constituting the PDP 70.

FIG. 6 is a view for showing a schematic structure of the PDP shown in FIG. 5.

The PDP shown in FIG. 6 is provided with an address driver 71, a data driver 72, and discharge cells 73˜78. The address driver 71 and the data driver 72 select certain discharge cells 73˜78 in response to an address pulse and a data pulse applied from the PDP driver 60. Further, if all the discharge cells on line 1 are not selected and all the discharge cells on line 2 are selected by an address pulse, the discharge cells on the line 2 are applied with a predetermined voltage applied from the address driver 71, whereas the address pulse is not applied to the line 1. Accordingly, parasitic capacitance Cp is generated by a potential difference between the line 1 and the line 2. At this time, upon applying a pulse to the line 2 from the address driver 71 due to the parasitic capacitance Cp, more electric current should be applied to the line 2 depending upon the capacity of the parasitic capacitance Cp, so that the address driver 71 should unnecessarily supply more current, causing a problem that the address driver 71 is damaged according to such a load increase.

### SUMMARY

The present invention has been devised to solve the above problem, so it is an aspect of the present invention to provide an image display device having functions for protecting an address driver.

In order to achieve the above aspect, an image display device having functions for protecting an address driver, comprises a panel provided with address electrodes and data electrodes; a scaler for converting an input image signal to fit into a resolution of the panel; an address driver and a data driver for driving the address electrodes and the data electrodes, respectively, in response to an image signal from the scaler; and a luminance control means for comparing line by line changes of the image signal outputted from the scaler, changing luminance of the image signal outputted from the scaler according to a result of the comparison, and changing the number of operations of the address driver.

Preferably, the luminance control means includes a line delay unit for delaying the image signal outputted from the scaler by a predetermined period of time, a line comparison part for comparing luminance of the pixels for the image signals outputted from the line delay unit and the scaler, a counter for counting the number of occurrences of luminance differences among the pixels compared in the comparator, and a luminance control part for controlling the scaler in response to a result of the counting of the counter and changing the luminance of the image signal outputted from the scaler.

Preferably, the predetermined period of time is a time period of the image signal outputted line by line from the scaler.

Preferably, the luminance control part includes a luminance data storage for storing luminance data for decreasing the luminance level by level; and a microcomputer for controlling the luminance data storage to output to the scaler corresponding luminance data out of luminance data stored in the luminance data storage in response to a counting value outputted from the counter.

Preferably, the image display device further comprises a pixel pattern detector for detecting an on and off pattern of data of individual pixels constituting the image signal outputted to each line, and applying the detected pattern to the luminance control part in order for the luminance control part to change the luminance of the image signal outputted from the scaler.

In order to achieve the above aspect, a method for protecting an address driver in an image display device having a panel provided with address electrodes and data electrodes, a scaler for converting an input image signal to fit into a resolution of the panel, an address driver and a data driver for driving the address electrodes and the data electrodes, respectively, in response to an image signal from the scaler, comprises steps of comparing line by line changes of the image signal outputted from the scaler, changing luminance of the image signal outputted from the scaler according to a result of the comparison, and changing the number of drives of the address driver based on the changed luminance.

Preferably, the luminance change step includes steps of comparing the image signal from the scaler line by line, and counting the number of occurrences of luminance differences among pixels constituting the lines, and changing the luminance of the image signal outputted from the scaler according to the number of luminance changes counted.

Preferably, the counting step includes steps of delaying the image signal outputted from the scaler by a predetermined period of time, comparing luminance among pixels for the image signal outputted from the scaler and the image signal delayed by the time period, and counting the number of luminance differences among the pixels.

Preferably, the predetermined period of time is a time period of the image signal outputted line by line from the scaler.

Hereinafter, the present invention will be described in detail with reference to the accompanying drawings.

### BRIEF DESCRIPTION OF THE DRAWINGS

The invention will be described in detail with reference to the following drawings in which like reference numerals refer to like elements, and wherein:

FIG. 1 is a vertically cross-sectioned view for showing a discharge cell constituting a plasma display device;

FIG. 2 is a graph for showing discharge characteristics of the discharge cell shown in FIG. 1;

FIG. 3 is a view for showing a structure of a commercialized plasma panel;

FIG. 4 is a view for explaining a luminance representation method for a plasma panel;

FIG. 5 is a block diagram for conceptually showing a conventional plasma display device;

FIG. 6 is a view for showing a schematic structure of the plasma panel shown in FIG. 5;

FIG. 7 is a block diagram for showing an image display device having functions for protecting an address driver according to an exemplary embodiment of the present invention;

FIG. 8a and FIG. 8b are views for explaining a comparison process of a line comparator shown in FIG. 7; and

FIG. 9 is a flow chart for explaining a method for protecting an address driver according to an exemplary embodiment of the present invention.

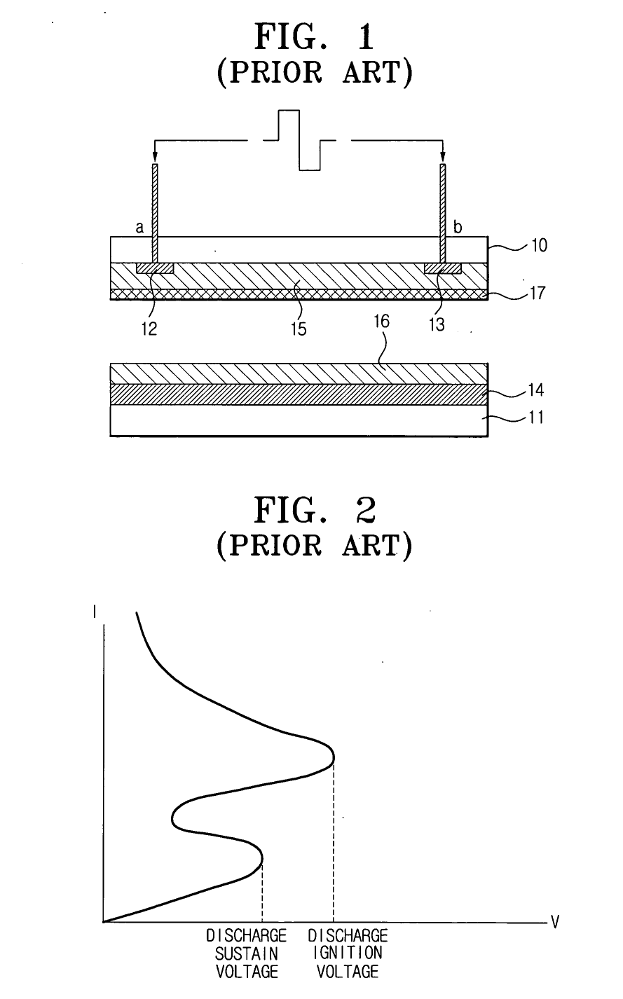

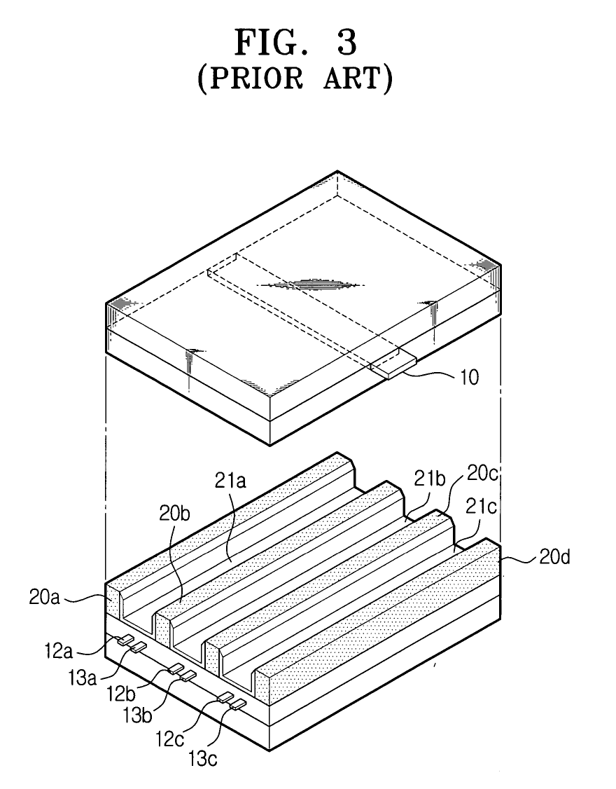

### DETAILED DESCRIPTION OF AN EXEMPLARY EMBODIMENT

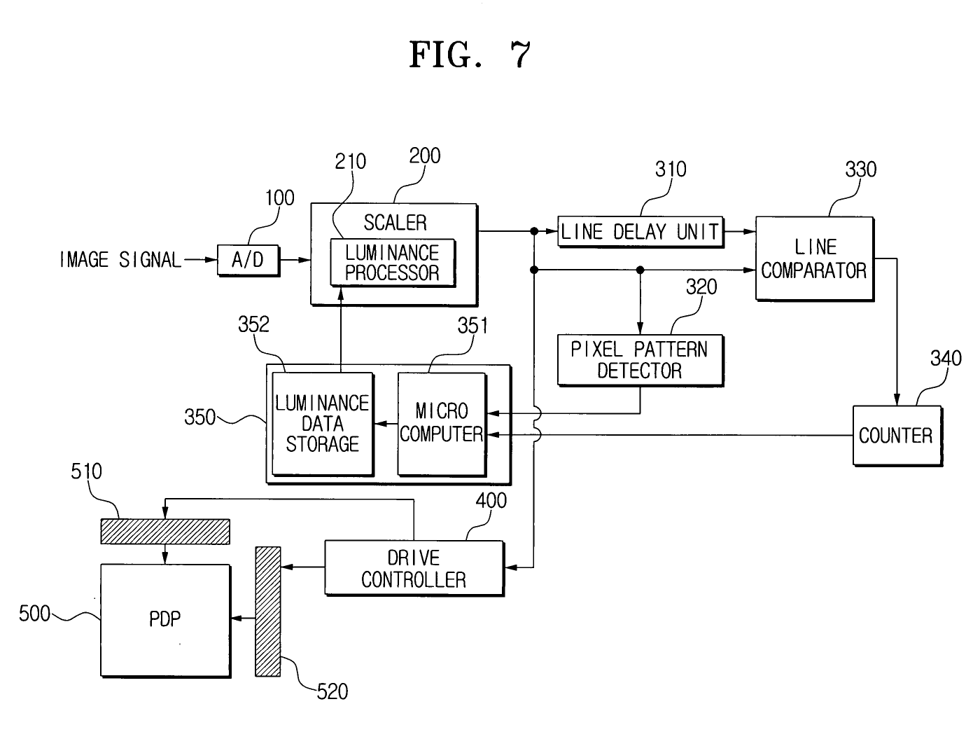

FIG. 7 is a block diagram for showing an image discharge device having functions for protecting an address driver according to an exemplary embodiment of the present invention.

An image display device shown in FIG. 7 has an A/D converter 100, a scaler 200, a line delay unit 310, a pixel pattern detector 320, a line comparator 330, a counter 340, a luminance controller 350, a drive controller 400, and a PDP 500.

The A/D converter 100 converts into a digital image signal an analog image signal (RGB signal) applied from a tuner (not shown) or a personal computer (not shown).

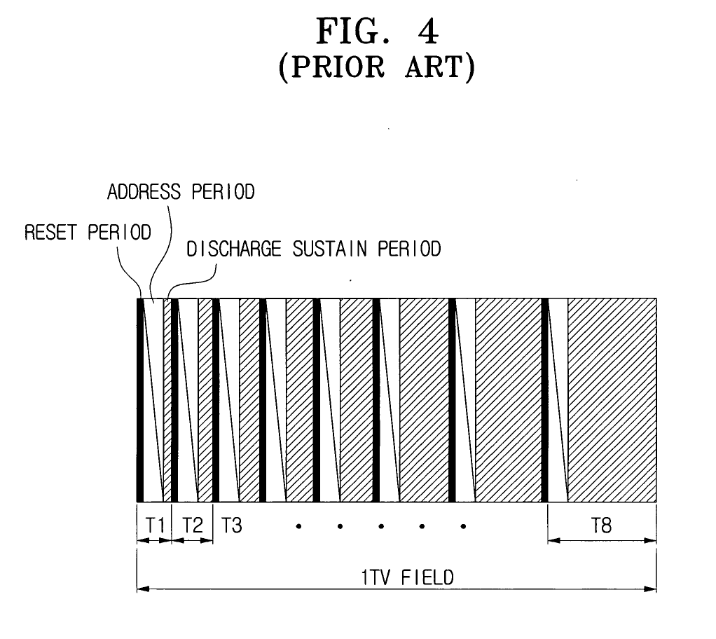

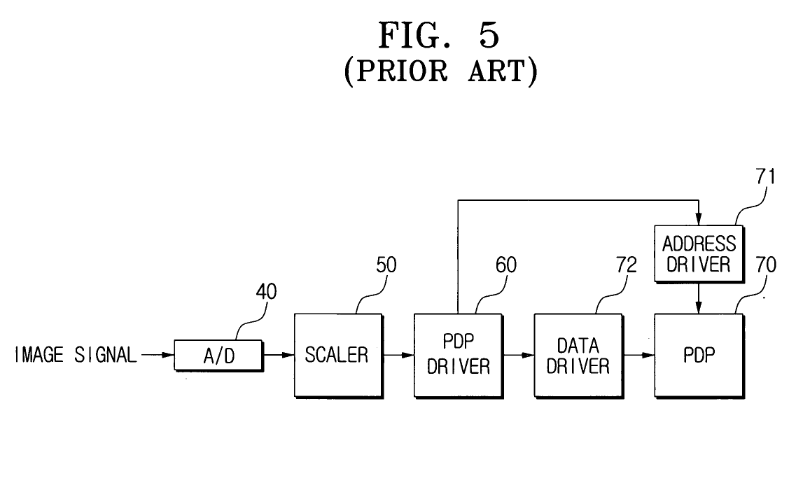

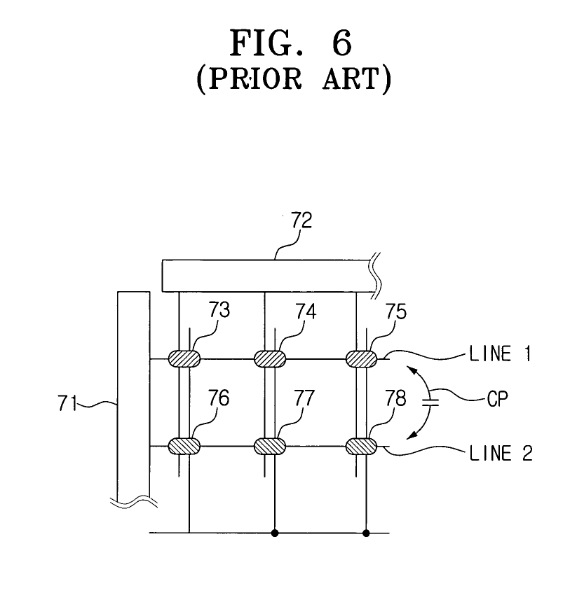

The scaler 200 converts the digital image signal to a resolution set to the PDP 500. In general, an analog image signal applied to the A/D converter 100 from a tuner (not shown) or a personal computer (not shown) has resolutions of 640×480 and 800×600, whereas an image display device such as PDP has a resolution of 852×480. Therefore, the scaler 200 converts a resolution of a digital image signal outputted from the A/D converter 100 to a resolution, for example, 852×480, fit for the PDP 500. Further, the scaler 200 has a luminance processor 210 therein, and can change the luminance of a digital image signal. The detailed descriptions have been made in FIG. 4 on the method for changing the luminance for a digital image signal inputted from the scaler 200, so further descriptions on the method for the change will be omitted.

The drive controller 400 inputs a digital image signal converted to be fit for a predetermined resolution, for example, 852×480, from the scaler 220, and converts the digital image signal to drive the PDP 500. The PDP 500 is provided with an address driver 510 and a data driver 520. The address driver produces an address pulse to selectively enable individual lines constituting the PDP 500 in response to a digital image signal outputted line by line from the scaler 200. The data driver generates and supplies an address pulse to the PDP 500 according to image information, for example, image information on 852 pixels, corresponding to a line selected by the address driver 510. The drive controller 400 supplies to the address driver 510 and the data driver 520 address information and data information corresponding to a digital image signal outputted from the scaler 200.

The PDP 500 displays images in response to such address pulse and data pulse.

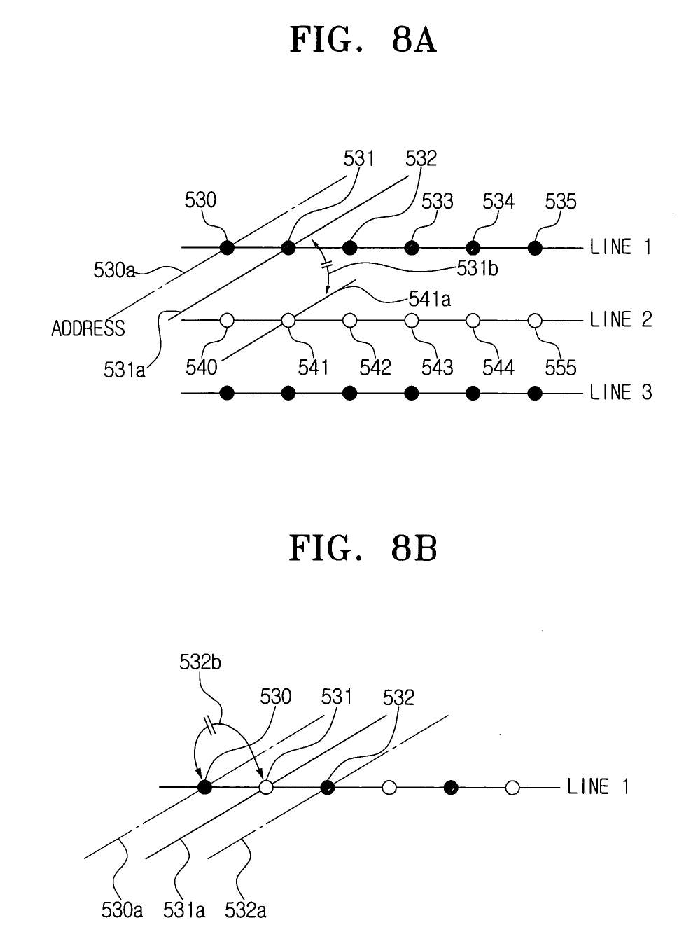

Hereinafter, descriptions are made of the line delay unit 310, line comparator 330, counter 340, and luminance controller 350, with reference to a pattern view of FIG. 8a.

The line delay unit 310 delays by a predetermined time a digital image signal outputted line by line from the scaler 200. The line delay unit 310 delays time by a time period of an inputted digital image signal. Therefore, the line comparator 330 is applied with a digital image signal directly inputted from scaler 200 in real time and a digital image signal delayed by one period.

The line comparator 330 compares line by line the digital image signal directly inputted from the scaler 200 and the digital image signal delayed by one period.

FIG. 8a is a view for showing part of pixels constituting the PDP 500, and for explaining operations of the line comparator 330.

Of pixels shown in FIG. 8a, the pixels 530˜535 located on the line 1 are selected by the address driver 510 to be in “on” state, and pixels 540˜545 located on the line 2 are in “off” state. The individual pixels 530˜545 are selected by an address pulse applied to corresponding address lines, for example, 530a, 531a, 541a, and so on. At this time, a small amount of capacitance is induced between address lines of line 1 and line 2, and the amount of capacitance increases when a potential difference between the line 1 and line 2 is produced. Referring to FIG. 8a, the line comparator 330 inputs a digital image signal for the line 1 which is outputted from the scaler 200, and a digital image signal for the line 2 which is delayed by one period by the line delay unit 310. Next, of pixels located on the line 1 and line 2, the line comparator 330 compares pixels, for example, 530 and 540, to each other that are located in the same spot in the vertical direction. If different from each other as a result of the comparison, the line comparator 330 outputs a pulse of logic “1” to the counter 340, and, if equal to each other, outputs a pulse of logic “0” to the counter 340.

The counter 340 counts the number of output values having logic “high” from the line comparator 330 during the period of the digital image signal applied to the line 1.

For example, for the pixels 530˜545 arrayed as shown in FIG. 8a, the counter 340 inputs and counts six pulses of logic “high” from the line comparator 330.

The luminance controller 350 controls the scaler 200 according to the number of pulses applied from the counter 340 during a certain amount of time to change the luminance of a digital image signal outputted from the scaler 200.

Preferably, the luminance controller 350 has a luminance data storage 352 and a microcomputer 351. The luminance data storage 352 has data values for decreasing luminance levels represented in the luminance processor 210 built in the scaler 200.

The microcomputer 351 selects luminance data applied to the luminance processor 210 from the luminance data storage 352 depending upon a count value outputted from the counter 340.

Table 1(below) shows luminance data selected in the luminance data storage 352 depending upon the number of pulses outputted from the counter 340, and the changes of luminance levels of a digital image signal outputted from the scaler 200 according to the luminance data.

TABLE 1

| | 2⁰ | 2¹ | 2² | 2³ | 2⁴ | 2⁵ | 2⁶ | 2⁷ |
|---|---|---|---|---|---|---|---|---|
| | 1 | 1 | 1 | 1 | 1 | 1 | 1 | 1 |
| −1 | 0 | 1 | 1 | 1 | 1 | 1 | 1 | 1 |
| −2 | 1 | 0 | 1 | 1 | 1 | 1 | 1 | 1 |
| −3 | 0 | 0 | 1 | 1 | 1 | 1 | 1 | 1 |

As shown in Table 1, in a case in which the initial luminance level of a digital image signal applied to the scaler 200 is a level of 256, that is, when all the subfields 2⁰˜2⁷ are in logic “1”, the luminance level of the digital image signal outputted from the luminance processor 210 decreases based on luminance data, for example, −1, −2, −3, and the like, applied from the luminance data storage 352. In case of luminance data of −3, the luminance of a digital image signal outputted from the scaler 200 has a level of 252 (00111111), which does not show a big difference from the luminance level of 255. At this time, the subfields 2⁰ and 2¹ are turned off. Therefore, when an address pulse is outputted from the address driver 510 due to a digital image signal outputted from the scaler 200, any address pulse for driving the corresponding subfields is not applied to the PDP 500 during time periods corresponding to subfields 2⁰ and 2¹. That is, the number of operations of the address driver 510 decreases, and any voltage and current are not applied to address lines provided for the address driver 510, so value of capacitance 531b induced between address lines decreases, and current consumption due to the parasitic capacitance also decreases. Therefore, when the address driver 510 applies an address pulse to the PDP 500, an invalid current decreases that occurs due to parasitic capacitance between address lines, to thereby protect the address driver 510.

FIG. 8b is a view for explaining operations of a pixel pattern detector 320. The pixel pattern detector 320 compares image signals outputted to individual lines from the scaler 200 and detects the transition number of image signals. For example, as shown in FIG. 8b, an on/off pattern is detected between pixels 530 and 531 arranged on the line 1. FIG. 8b shows all the five-time pattern transition occurrences. Such pattern transitions increase parasitic capacitance among address lines 530a, 531a, and 532a for driving the individual pixel 530, 531, and 532. For example, with the address line 530a and the address line 531a turned on and off respectively, a certain parasitic capacitance is produced due to a potential difference between the two address lines 530a and 531a. The pixel pattern detector 320 detects and applies to the microcomputer 351 the number of times of such pattern transition occurrences, and the microcomputer 351 sends out to the luminance processor 210 built in the scaler 200 the luminance data stored in the luminance data storage 352 according to the number of times of pattern transitions detected from the pixel pattern detector 320, to lower the luminance value of a digital image signal outputted from the scaler 200.

The process for detecting a pixel pattern is performed on each line for an image signal outputted line by line from the scaler 200, and a method for decreasing the luminance in the luminance processor 210 employs the same method as shown above in Table 1. Accordingly, the number of subfields to be driven by the address driver 510 decreases, so that the load of the address driver 510 decreases.

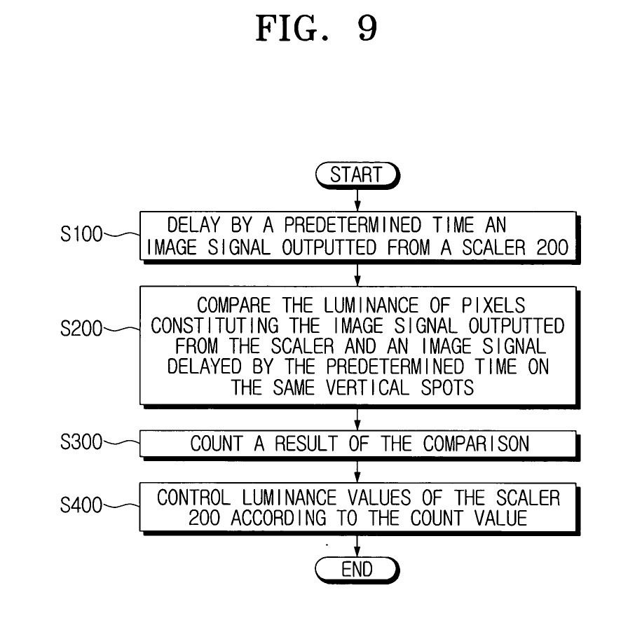

FIG. 9 is a flow chart for showing a method for protecting an address driver according to an exemplary embodiment of the present invention.

First, the line delay unit 310 delays a digital image signal outputted line by line from the scaler 200 by the period of a digital image signal outputted line by line (S100). Next, the line comparator 330 compares the luminance of pixels for the image signal outputted from the scaler 200 and the image signal outputted from the line delay unit 310 (S200). Referring to FIG. 8a, of the pixels on the line 1 and the line 2, the line comparator 330 compares the pixels 530 and 540, pixels 531 and 541, and pixels 532 and 542, respectively, and detects the luminance differences. Likewise, the line comparator 330 compares the remaining pixels in the same method. In FIG. 8a, six pixels are all compared, and, when counted, the counter 300 has a count value of 6 (S300). Based on the count value, the microcomputer 351 controls the luminance data storage 352 to control the luminance processor 210 built in the scaler 200. Accordingly, the luminance processor 210 decreases subfields one by one based on the luminance data when a digital image signal is outputted, to thereby decrease the number of drives of the address driver 510.

That is, if the address driver 510 applies an address pulse to the PDP 500, the invalid current decreases that occurs due to a parasitic capacitance between address lines and damage to the address driver 510 due to an overload is prevented.

As described above, the present invention decreases a parasitic capacitance in an address driver for driving a PDP, to thereby prevent the address driver from being overloaded.

While the invention has been shown and described with reference to a certain exemplary embodiment thereof, it will be understood by those skilled in the art that various changes in form and details may be made therein without departing from the spirit and scope of the invention as defined by the appended claims.

What is claimed is:

1. An image display device having functions for protecting an address driver, the device comprising:
a panel provided with address electrodes and data electrodes;
a scaler for converting an input image signal to fit into a resolution of the panel;
an address driver and a data driver for driving the address electrodes and the data electrodes, respectively, in response to an image signal from the scaler; and
a luminance control means for comparing line by line changes of the image signal outputted from the scaler, changing luminance of the image signal outputted from the scaler according to a result of the comparison, and changing a number of operations of the address driver.

2. The image display device as claimed in claim 1, wherein the luminance control means includes:
a line delay unit for delaying the image signal outputted from the scaler by a predetermined period of time;
a line comparison part for comparing luminance of the pixels for the image signals outputted from the line delay unit and the scaler;
a counter for counting a number of luminance differences among the pixels compared in the comparator; and
a luminance control part for controlling the scaler in response to a result of the counting of the counter and changing the luminance of the image signal outputted from the scaler.

3. The image display device as claimed in claim 2, wherein the predetermined period of time is a time period of the image signal outputted line by line from the scaler.

4. The image display device as claimed in claim 2, wherein the luminance control part includes:
a luminance data storage for storing luminance data for decreasing the luminance level by level; and
a microcomputer for controlling the luminance data storage to output to the scaler corresponding luminance data out of luminance data stored in the luminance data storage in response to a counting value outputted from the counter.

5. The image display device as claimed in claim 1, further comprising a pixel pattern detector for detecting an on and off pattern of data of individual pixels constituting the image signal outputted to each line, and applying the detected pattern to the luminance control part in order for the luminance control part to change the luminance of the image signal outputted from the scaler.

6. A method for protecting an address driver in an image display device having a panel provided with address electrodes and data electrodes, a scaler for converting an input image signal to fit into a resolution of the panel, and an address driver and a data driver for driving the address electrodes and the data electrodes, respectively, in response to an image signal from the scaler, the method comprising steps of:
comparing line by line changes of an image signal outputted from the scaler;
changing luminance of the image signal outputted from the scaler according to a result of the comparison; and
changing a number of drives of the address driver based on the changed luminance.

7. The method as claimed in claim 6, wherein the luminance change step includes steps of:
comparing the image signal ouputted from the scaler line by line, and counting a number of luminance changes among pixels constituting the lines; and
changing the luminance of the image signal outputted from the scaler according to the number of luminance changes counted.

8. The method as claimed in claim 7, wherein the counting step includes steps of:
delaying the image signal outputted from the scaler by a predetermined period of time;
comparing luminance among pixels for the image signal outputted from the scaler and the image signal delayed by the predetermined period of time; and
counting a number of occurrences of the luminance differences among the pixels.

9. The method as claimed in claim 8, wherein the predetermined period of time is a time period of the image signal outputted line by line from the scaler.
